(19) United States
(12) Patent Application Publication
(10) Pub. No.: US 2026/0370394 A1
(43) Pub. Date: Nov. 19, 2026

(54) METHODS, ARCHITECTURES, APPARATUSES AND SYSTEMS FOR THROUGHPUT PERFORMANCE IMPROVEMENT FOR NON-TERRESTRIAL NETWORKS

(71) Applicant: InterDigital Patent Holdings, Inc., Wilmington, DE (US)

(72) Inventors: Brian Martin, Farnham (GB); Dylan Watts, Montreal (CA); Keiichi Kubota, Tokyo (JP); Oumer Teyeb, Montreal (CA)

(73) Assignee: InterDigital Patent Holdings, Inc., Wilmington, DE (US)

(21) Appl. No.: 19/746,894

(22) Filed: Jul. 20, 2026

Related U.S. Application Data
(63) Continuation of application No. 18/702,660, filed on Oct. 18, 2022, now abandoned.

(30) Foreign Application Priority Data
Oct. 19, 2021 (EP) 21203479.7
Jul. 5, 2022 (EP) 22183084.7

(51) Int. Cl. H04L 1/1812; H04L 5/00

(52) U.S. Cl. CPC H04L 1/1812; H04L 5/0055

(57) ABSTRACT

Procedures, methods, architectures, apparatuses, systems, devices, and computer program products directed to control throughput performance. In an embodiment, a method, implemented in a WTRU, for controlling throughput, comprises: determining a first mode of transmission of a first packet of data; transmitting, to a network (NW) element, the packet data based on the first mode of transmission; determining a second mode of transmission of a second packet of data based on the type of the second packet of data, wherein the second mode of transmission differs from the first mode of transmission.

### CROSS-REFERENCE TO RELATED APPLICATION

This application is a continuation of U.S. Non-Provisional patent application Ser. No. 18/702,660, filed Apr. 18, 2024, which is the U.S. National Stage Application under 35 U.S.C. § 371 of International Patent Application No. PCT/US2022/047011, filed Oct. 18, 2022, which claims the benefit of, and/or priority to, European Patent Application No. 21203479.7, filed Oct. 19, 2021, and European Patent Application No. 22183084.7, filed Jul. 5, 2022, each of which is incorporated herein by reference.

### FIELD OF THE INVENTION

The present disclosure is generally directed to the fields of communications, software and encoding, including, for example, to methods, architectures, apparatuses, systems directed to throughput performance improvement for non-terrestrial networks.

### BACKGROUND

For non-terrestrial networks (NTN), it is known that for an acknowledged mode of a radio link control (RLC), a wireless transmit/receive unit (WTRU) may need to store protocol data units (PDUs) for at least the RLC round-trip time (RTT) in case the PDU needs to be retransmitted. WTRU memory requirement may be directly proportional to RLC RTT. For NTN, an hybrid automatic repeat request (HARQ) RTT may be up to 500 ms (10 times more than worst case terrestrial RLC RTT). RLC RTT may (e.g., currently) assume some HARQ retransmissions for reliability of RLC ACK. By re-using this assumption, the memory requirement may be 30-60 times greater for NTN WTRU as compared with a WTRU connected to a terrestrial base station (e.g., gNB).

High-reliable HARQ (e.g., using stop and wait HARQ ACK) may introduce unnecessary delay such that: throughput may be (e.g., severely) limited—MAC may not accept new data if HARQ processes are retransmitting, and retransmissions depend on the HARQ RTT—long RTT means long retransmission times; L2 memory requirement may be excessive; automatic retransmission of every HARQ PDU to obtain reliability may (e.g., severely) impact capacity (e.g., 2 or 3 times unnecessary transmissions).

There is a need for improving throughput for non-terrestrial network systems.

### SUMMARY

In one embodiment, a method implemented in a wireless transmit/receive unit, (WTRU) may comprise: receiving information indicating a plurality of hybrid automatic repeat request (HARQ) process configurations including a first mode of HARQ transmission and a second mode of HARQ transmission, wherein the first mode of HARQ transmission is different from the second mode of HARQ transmission; receiving a negative acknowledgement (NACK) for a radio link control (RLC) protocol data unit (PDU) that was previously transmitted or re-transmitted using the first mode of HARQ transmission; in response to receiving NACK, determining to use the second mode of HARQ transmission for retransmission of the RLC PDU; and re-transmitting the RLC PDU using the second mode of HARQ transmission.

The first mode of HARQ transmission may allow for (e.g., may be based on) a single HARQ transmission, and wherein the second mode of HARQ transmission may allow for (e.g., may be based on) one or more HARQ automatic retransmissions.

The first mode of HARQ transmission may allow for (e.g., may be based on) a single HARQ transmission, and wherein the second mode of HARQ transmission may allow for (e.g., may be based on) HARQ feedback.

The first mode of HARQ transmission may allow for (e.g., may be based on) one or more HARQ transmission without HARQ feedback, and wherein the second mode of HARQ transmission may allow for (e.g., may be based on) one or more HARQ automatic retransmissions and/or blind retransmission.

The first mode of HARQ transmission may comprise a first number of re-transmissions, and the second mode of HARQ transmission may comprise a second number of retransmissions; and wherein the first number of retransmissions is different from the second number of retransmissions. The second mode of HARQ transmission may comprise an increased number of retransmissions or repetitions compared to the first mode of HARQ transmission in order to improve the reliability of HARQ transmission.

A transmit window associated with the prior transmission or re-transmission of the RLC PDU may be advanced responsive to receiving NACK and/or determining to use the second HARQ mode of transmission.

Determining to use the second mode of HARQ transmission for retransmission of the RLC PDU may comprise determining that the RLC PDU was previously transmitted or re-transmitted using the first mode of HARQ transmission.

Determining to use the second mode of HARQ transmission for retransmission of the RLC PDU may comprise determining that the RLC PDU is a type of acknowledged mode data PDU initial transmission.

Determining to use the second mode of HARQ transmission for retransmission of the RLC PDU may be based on channel quality indicator.

In one embodiment, a method implemented in a wireless transmit/receive unit (WTRU) may comprise: receiving information indicating a plurality of hybrid automatic repeat request (HARQ) process configurations including a first mode of HARQ transmission and a second mode of HARQ transmission, wherein the first mode of HARQ transmission is different from the second mode of HARQ transmission; receiving a retransmission grant for a radio link control (RLC) protocol data unit (PDU) that was previously transmitted or re-transmitted using the first mode of HARQ transmission; and re-transmitting the RLC PDU using the second mode of HARQ transmission, wherein the second mode of HARQ transmission may allow for (e.g., may be based on) on one or more blind HARQ retransmissions.

The first mode of HARQ transmission may comprise a first number of re-transmissions, and the second mode of HARQ transmission may comprise a second number of retransmissions; and wherein the first number of retransmissions is different from the second number of retransmissions. The second mode of HARQ transmission may comprise an increased number of retransmissions or repetitions compared to the first mode of HARQ transmission in order to improve the reliability of HARQ transmission.

In an embodiment, a wireless transmit/receive unit, WTRU, comprising a processor, a transceiver unit and a storage unit, may be configured to receive information indicating a plurality of hybrid automatic repeat request (HARQ) process configurations including a first mode of HARQ transmission and a second mode of HARQ transmission, wherein the first mode of HARQ transmission is different from the second mode of HARQ transmission. The WTU may be further configured to receive a negative acknowledgement (NACK) for a radio link control (RLC) protocol data unit (PDU) that was previously transmitted or re-transmitted using the first mode of HARQ transmission. In response to receive NACK, the WTRU may be configured to determine to use the second mode of HARQ transmission for retransmission of the RLC PDU; and configured to re-transmit the RLC PDU using the second mode of HARQ transmission.

The first mode of HARQ transmission may allow for (e.g., may be based on) a single HARQ transmission, and the second mode of HARQ transmission may allow for (e.g., may be based on) one or more HARQ automatic retransmissions.

The first mode of HARQ transmission may allow for (e.g., may be based on) a single HARQ transmission, and the second mode of HARQ transmission may allow for (e.g., may be based on) HARQ feedback.

The first mode of HARQ transmission may allow for (e.g., may be based on) one or more HARQ transmissions without HARQ feedback, and the second mode of HARQ transmission may allow (e.g., may be based on) one or more HARQ automatic retransmissions and/or blind retransmissions.

The first mode of HARQ transmission may comprise a first number of re-transmissions, and the second mode of HARQ transmission may comprise a second number of retransmissions; and first number of retransmissions is different from the second number of retransmissions. The second mode of HARQ transmission may comprise an increased number of retransmissions or repetitions compared to the first mode of HARQ transmission in order to improve the reliability of HARQ transmission.

A transmit window associated with the prior transmission or re-transmission of the RLC PDU may be advanced responsive to receiving NACK and/or determining to use the second HARQ mode of transmission.

Determining to use the second mode of HARQ transmission for retransmission of the RLC PDU may comprise determining that the RLC PDU was previously transmitted or re-transmitted using the first mode of HARQ transmission.

Determining to use the second mode of HARQ transmission for retransmission of the RLC PDU may comprise determining that the RLC PDU is a type of acknowledged mode data PDU initial transmission.

Determining to use the second mode of HARQ transmission for retransmission of the RLC PDU may be based on channel quality indicator.

In an embodiment, a wireless transmit/receive unit, WTRU, comprising a processor, a transceiver unit and a storage unit, may be configured to receive information indicating a plurality of hybrid automatic repeat request (HARQ) process configurations including a first mode of HARQ transmission and a second mode of HARQ transmission, wherein the first mode of HARQ transmission is different from the second mode of HARQ transmission. The WTRU may be further configured to receive a retransmission grant for a radio link control (RLC) protocol data unit (PDU) that was previously transmitted or re-transmitted using the first mode of HARQ transmission, and to re-transmit the RLC PDU using the second mode of HARQ transmission, wherein the second mode of HARQ transmission allows for (e.g., may be based on) one or more blind HARQ retransmissions.

The first mode of HARQ transmission may comprise a first number of re-transmissions, and the second mode of HARQ transmission may comprise a second number of retransmissions; and wherein the first number of retransmissions is different from the second number of retransmissions. The second mode of HARQ transmission may comprise an increased number of retransmissions or repetitions compared to the first mode of HARQ transmission in order to improve the reliability of HARQ transmission.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the FIGURES (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is system diagram illustrating an example of different interfaces defined in a Non-terrestrial networks (NTN);

FIG. 3 is a signaling diagram illustrating an example of Radio link control (RLC) round trip time (RTT) and L2 buffer requirement in Long Term Evolution (LTE) and new radio (NR); and

FIG. 4 is a signaling diagram illustrating an example of adapting hybrid automatic repeat request (HARQ) operation based on RLC protocol data unit (PDU) type.

FIG. 5 is a flow chart illustrating an example of a method implemented in a WTRU, for throughput performance improvement.

FIG. 6 is a flow chart illustrating another example of a method implemented in a WTRU, for throughput performance improvement.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

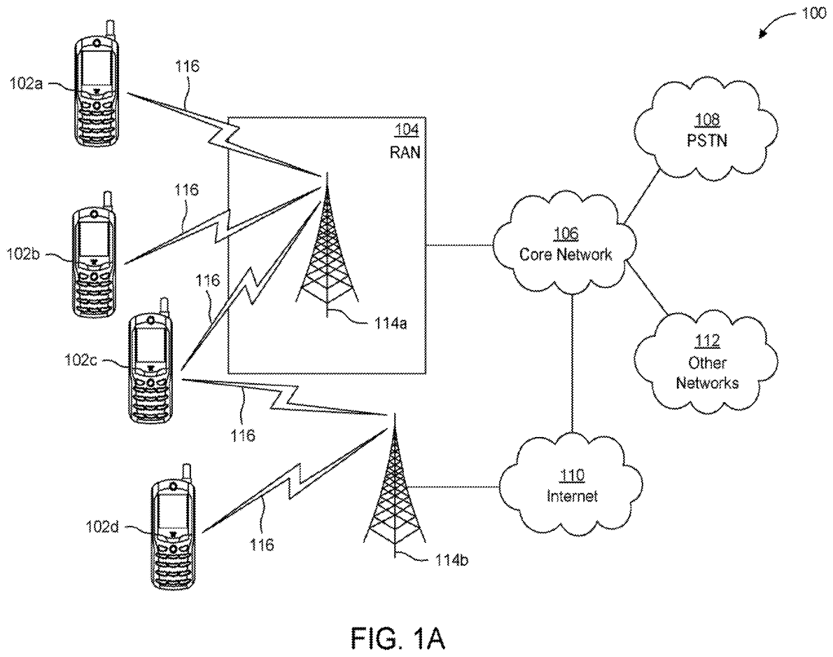

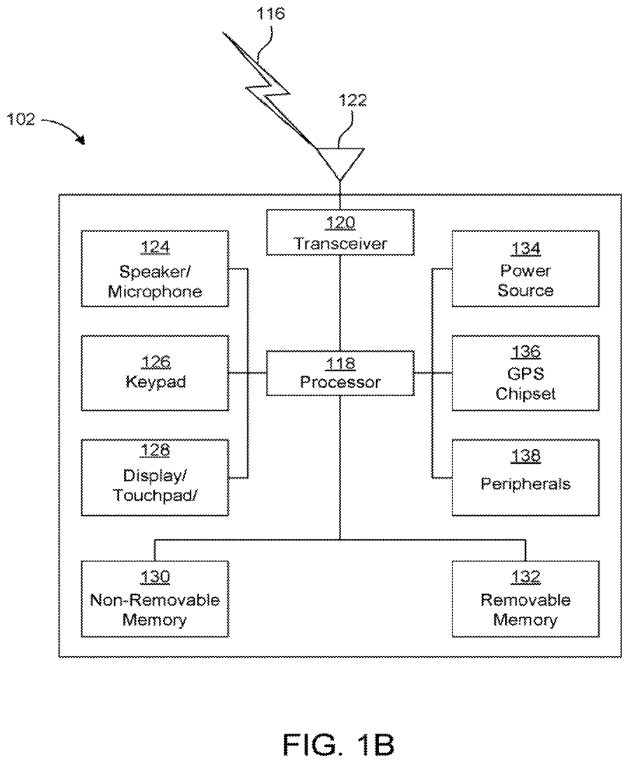

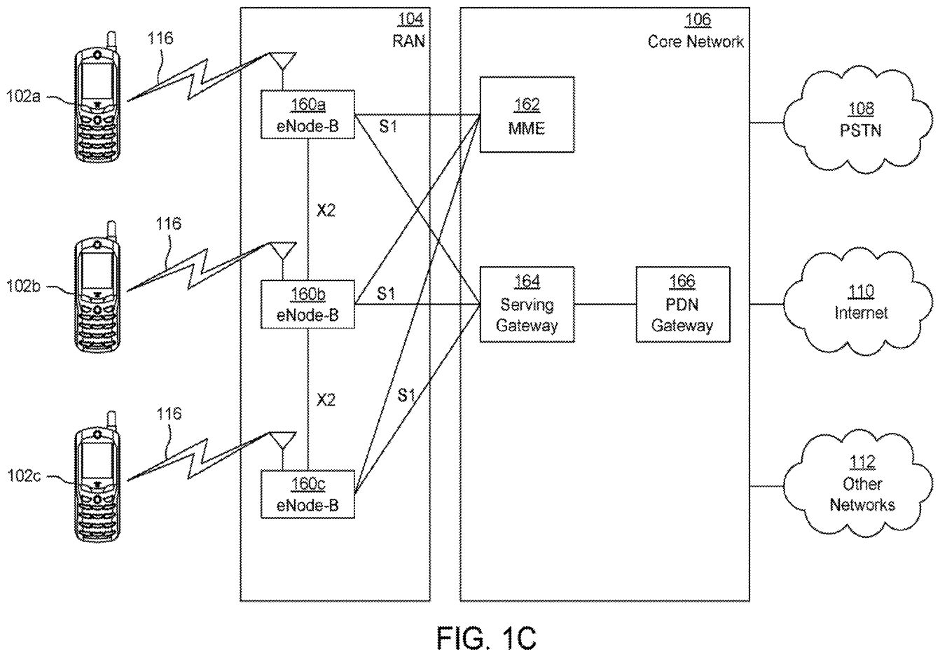

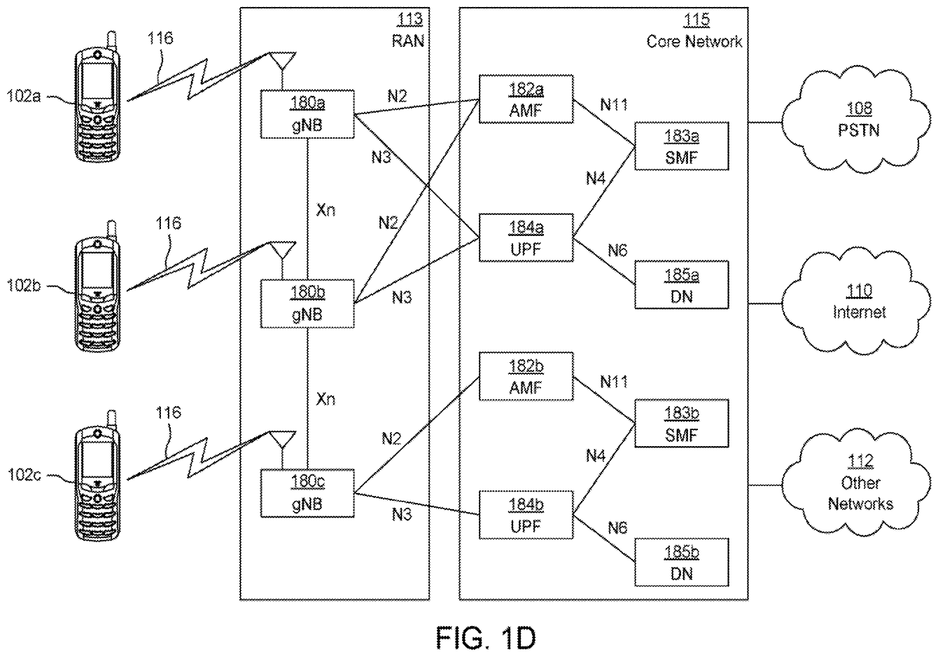

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Non-terrestrial networks (NTN) may facilitate deployment of wireless networks in areas where land-based antennas are impractical, for example due to geography or cost. It is envisioned that, coupled with terrestrial networks, NTN will enable truly ubiquitous coverage of wireless networks (e.g., 5G networks). Initial Rel-17 NTN deployments support basic talk and text anywhere in the world. It is expected that further releases coupled with proliferation of next-generation low-orbit satellites may enable enhanced services such as web browsing.

A basic NTN may consist of an aerial or space-borne platform which, via a gateway (GW), transports signals from a land-based based station (e.g., gNB) to a WTRU and vice-versa. Current Rel-17 NR NTN supports power class 3 WTRU with omnidirectional antenna and linear polarization, or a very small aperture antenna (VSAT) terminal with directive antenna and circular polarization. Support for LTE-based narrow-band IoT (NB-IoT) and eMTC type devices may be also expected to be standardized in Rel-17, based on recommendations from 3GPP TR 36.736 [3]. Regardless of device type, it is assumed all Rel-17 NTN WTRUs are Global navigation satellite system (GNSS) capable.

Aerial or space-borne platforms are classified in terms of orbit, with Rel-17 standardization focusing on low-earth orbit (LEO) satellites with altitude range of 300-1500 km and geostationary earth orbit (GEO) satellites with altitude at 35 786 km. Other platform classifications such as medium-earth orbit (MEO) satellites with altitude range 7000-25000 km and high-altitude platform stations (HAPS) with altitude of 8-50 km are assumed to be implicitly supported. Satellite platforms are further classified as having a “transparent” or “regenerative” payload. Transparent satellite payloads implement frequency conversion and RF amplification in both uplink and downlink, with multiple transparent satellites possibly connected to one land-based base station (e.g., gNB). Regenerative satellite payloads may implement either a base station (e.g., gNB or gNB Distributed Unit) onboard the satellite. Regenerative payloads may perform digital processing on the signal including demodulation, decoding, re-encoding, re-modulation and/or filtering.

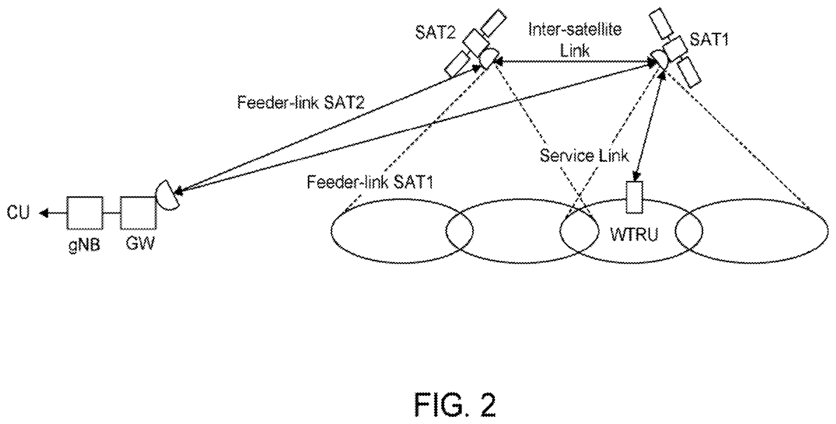

FIG. 2 show an example of different interfaces defined in a NTN. A Feeder-link is a wireless link between the GW and satellites (SAT1; SAT2). A Service link is Radio link between a satellite and a WTRU. An Inter-satellite Link (ISL) is a transport link between satellites (SAT1; SAT2). The ISL is supported by regenerative payloads and may be a 3GPP radio or proprietary optical interface.

Depending on the satellite payload configuration, different 3GPP interfaces may be used for each radio link. In a transparent payload, a NR-Uu radio interface may be used for both the service link and feeder-link. For a regenerative payload, the NR-Uu interface may be used on the service link, and a satellite radio interface (SRI) may be used for the feeder-link. 3GPP has not currently defined ISLs for Rel-17. A detailed UP/CP protocol stack for each payload configuration may be found in 3GPP TR 38.821 [1] Section 5.1 and 5.2.

An NTN satellite may support multiple cells, where each cell may consist of one or more satellite beams. Satellite beams cover a footprint on earth (like a terrestrial cell) and may range in diameter from 100-1000 km in LEO deployments, and 200-3500 km diameter in GEO deployments. Beam footprints in GEO deployments may remain fixed relative to earth, and in LEO deployments the area covered by a beam/cell may change over time due to satellite movement. This beam movement may be classified as “earth moving” where the LEO beam moves continuously across the earth, or “earth fixed” where the beam is steered to remain covering a fixed location until a new cell overtakes the coverage area in a discrete and coordinated change.

Due to the altitude of NTN platforms and beam diameter, the round-trip time (RTT) and maximum differential delay is larger than that of terrestrial systems. As an example, in a typical transparent NTN deployment, RTT may range from 25.77 milliseconds (LEO @ 600 km altitude) to 541.46 milliseconds (GEO) and maximum differential delay from 3.12 milliseconds to 10.3 milliseconds. The RTT of a regenerative payload may be around half that of a transparent payload, as a transparent configuration may consist of both the service and feeder links, whereas the RTT of a regenerative payload may consider the service link only. To minimize impact to existing NR systems (e.g., to avoid preamble ambiguity or properly time reception windows), prior to initial access, a WTRU may perform timing pre-compensation.

The pre-compensation procedure may require the WTRU to obtain its position via any of GNSS, the feeder-link (or common) delay and satellite position via satellite ephemeris data. The satellite ephemeris data may be periodically broadcast in system information, and may contain the satellite speed, direction, and velocity. The WTRU may estimate the distance and delay from the satellite, and then add the feeder-link delay component to obtain the full WTRU to base station (e.g., gNB) RTT, which is then used to offset timers, reception windows, or timing relations. Frequency compensation may be performed by the network.

Other key enhancements in Rel-17 NTN, concern WTRU mobility and measurement reporting. As related in 3GPP TR 38.821, the difference in Reference Signal Received Power (RSRP) between cell center and cell edge may be not as in terrestrial systems. This, coupled with the much larger region of cell overlap, may result in traditional measurement-based mobility to become less reliable in an NTN environment. 3GPP has therefore introduced new conditional handover and measurement reporting triggers relying on location and time, with details to be confirmed. Enhanced mobility is of interest in LEO deployments where, due to satellite movement, even a stationary WTRU is expected to perform mobility approximately every 7 seconds (depending on deployment characteristics).

A radio link control (RLC) entity may be configured to perform data transfer in one of the following three modes: Transparent Mode (TM), Unacknowledged Mode (UM) or Acknowledged Mode (AM). Consequently, an RLC entity is categorized as a TM RLC entity, an UM RLC entity or an AM RLC entity depending on the mode of data transfer that the RLC entity is configured to provide.

An AM RLC entity consists of a transmitting side and a receiving side. The transmitting side of an AM RLC entity receives RLC Service Data Units (SDUs) from upper layer and sends RLC Packet Data Units (PDUs) to its peer AM RLC entity via lower layers. The receiving side of an AM RLC entity delivers RLC SDUs to upper layer and receives RLC PDUs from its peer AM RLC entity via lower layers.

An AM RLC entity (e.g., AM RLC of WTRU or AM RLC of gNB) may poll its peer AM RLC entity in order to trigger or to perform Status reporting at the peer AM RLC entity. The polling may be done by setting a polling (P) bit at the RLC header of a Packet Data Convergence Protocol (PDCP) PDU.

The RLC entity may be configured to trigger polling in any of the following several ways. On way is “Poll PDU”: trigger polling every specified number of PDUs (value can range from 4 PDUs to infinity, where infinity is equivalent to turning of the poll PDU). Another way is “Poll Byte”: trigger polling every time the RLC transmitter has transmitted a certain number of bytes (new data) since the last poll was sent (value can range from 1 KB to infinity, where infinity is equivalent to turning of the poll Byte).

After sending a poll, the RLC entity may start a poll re-transmission timer (t-PollRetransmit), which can have a value ranging from 5 milliseconds to 4 seconds. If a status report is received while the timer is running, the timer may be stopped. If the time expires before a status report is received, the RLC entity may trigger the poll sending (even if the poll PDU and poll byte conditions are not fulfilled yet).

As already stated, due to the altitude of NTN platforms and beam diameter, the round-trip time (RTT) and maximum differential delay is larger than that of terrestrial systems. In a typical transparent NTN deployment, RTT can range from 25.77 ms (LEO @ 600 km altitude) to 541.46 ms (GEO) and maximum differential delay from 3.12 ms to 10.3 ms.

According to 3GPP TS 38.306 the L2 buffer requirement for NR devices is as follows: Total layer 2 buffer size=MaxDLDataRate*RLC RTT+MaxULDataRate*RLC RTT. The RLC RTT for NR cell group per Subcarrier Spacing (SCS) is given in Table 1:

TABLE 1

| | |
|---|---|
| SCS (kHz) | RLC RTT (ms) |

| | | |
|---|---|---|
| 15 | KHz | 50 |
| 30 | KHz | 40 |
| 60 | KHz | 30 |
| 120 | KHz | 20 |

The document in R2-082406 “LTE assumptions for L2 buffer requirement” Ericsson provides more detail on how the RLC RTT is estimated for LTE: “A reasonable value for the RLC RTT depends on the number of hybrid automatic repeat request (HARQ) retransmissions targeted, the configuration of the reordering timer and RLC polling triggers. Assuming e.g., that maximum 5 HARQ retransmissions are supported and that the RLC polls for every 32nd (Transmission Time Interval) TTI, the maximum RLC RTT can be estimated to be 5*8 milliseconds+32 milliseconds=72 milliseconds.”

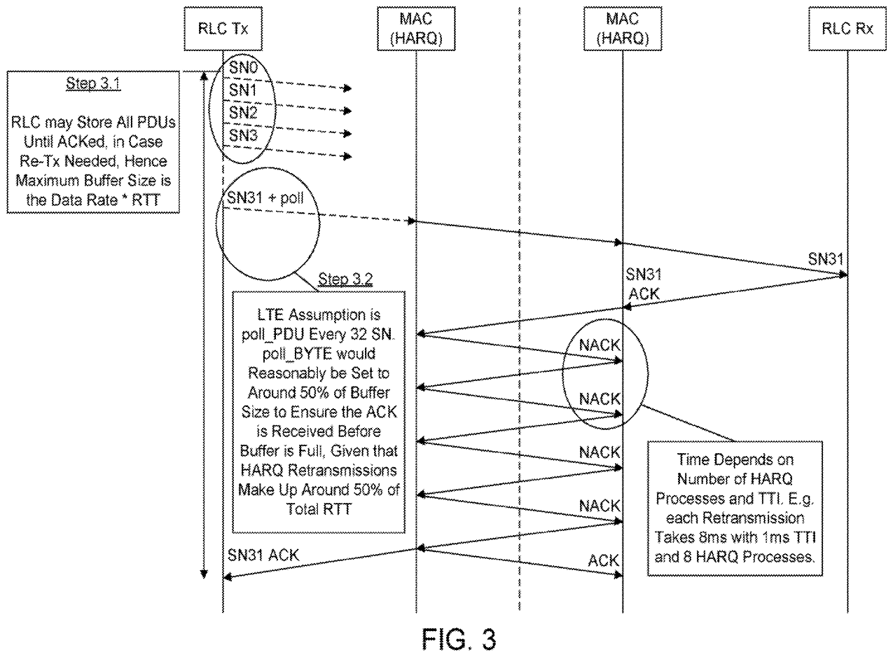

Based on the figures provided in R2-082406 “LTE assumptions for L2 buffer requirement” Ericsson, the message sequence chart in FIG. 3 shows example of how the elements of RLC RTT impact the L2 buffer requirement.

At step 3.1, a transmitting AM RLC entity (RLC Tx) may store PDUs which have been transmitted but not acknowledged in the RLC retransmission buffer (L2 buffer) in order that they may be retransmitted if necessary. In most cases, any “lost” RLC PDUs (e.g., not correctly received after maximum HARQ retransmissions) may be detected by the receiving RLC entity (RLC Rx), which may trigger an RLC status report (which contains ACK/NACK information for RLC PDUs) which in turn would trigger an RLC retransmission. During periods in which the radio conditions are good, it may be possible that transmitted RLC PDUs are received without error for periods of time which exceed the RLC RTT (e.g., HARQ corrects all of the errors, resulting in successfully RLC PDU delivery). In this case, a mechanism may be used in order to advance the RLC transmit window to free memory/RLC Sequence Numbers (SN0, SN1, SN2, SN3) in order that the L2 buffer can accept new data and continue transmitting data at the maximum (or close to maximum) supported data rate.

At step 3.2, this mechanism may rely on the transmitting RLC entity (RLC Tx) setting a “poll” bit in order to request that the receiving RLC entity (RLC Rx) generates a status report which may contain a successful acknowledgement for RLC SNs received since the previous status report, which upon being received at the transmitting RLC entity, may allow the transmitting RLC entity to advance the transmit window allowing new data to be transmitted.

The RLC RTT may be therefore estimated as the amount of time it takes before a poll bit is set, plus the amount of time it may take the STATUS report to be successfully received, taking into account a number of HARQ retransmissions (of the STATUS report and/or the RLC PDU containing the poll bit). The L2 buffer may be sum of the amount of data that may be transmitted and stored during this time in the uplink and the downlink (e.g., if data is being transmitted and received in both uplink and downlink at the maximum supported rate).

A reasonable block error rate (BLER) target for HARQ may be around 10% with reliability up to 0.1% errors with 3 HARQ transmissions (e.g., initial transmission+2 retransmissions). The BLER target may be a trade-off between spectral efficiency in the network (e.g., the amount of power needed to transmit) and reliability. Any residual errors may be dealt with by RLC. This ensures fast and reliable throughput achieved by a combination of HARQ fast retransmission and RLC for robustness. The combination of HARQ at MAC layer and ARQ at RLC layer may provide an efficient and robust transfer of data. The (e.g., fast) feedback and the combining at HARQ may allow for the majority of errors to be corrected (e.g., quickly). ARQ at RLC may include transmission of STATUS reports (ACK/NACK) using the HARQ mechanism, allowing a highly reliable error correction within L2 of the radio access protocol, while remaining efficient because new data can be transmitted at the maximum supported rate. The control signalling overhead and device memory requirement may be minimised.

Introducing very long HARQ RTT in NTN may break all of these assumptions above, the main element of RLC RTT may become the RTT of a single HARQ transmission and fast feedback at HARQ may be no longer possible.

Simply disabling HARQ to ensure that new data can be transmitted at the current rate may cause problems further up the stack because RLC/PDCP/TCP would need to deal with retransmission for 10% of the time. TCP may adapt (e.g., reduce) the throughput based on lower layer errors—these are treated as congestion since TCP was originally designed for fixed line networks. Long delays e.g., at HARQ may also be treated as errors (due to TCP ARQ).

Using regular stop-and-wait HARQ to achieve reliable transmission may cause excessive delays due to very long retransmission times. Even with 32 HARQ processes the HARQ RTT may be the limitation rather than the number of processes or polling strategy.

Using unacknowledged mode (UM) RLC may limit the use-case of NTN to be suitable only for low-reliability services (e.g., voice codecs may be designed to be tolerant of some packet loss). RLC mode may be configured based on QoS requirement. Services requiring a low BLER may not use UM and therefore the current NTN design may not support high QoS services.

For AM, WTRU may need to store PDUs for at least the RLC RTT in case the PDU needs to be retransmitted such that: memory requirement may be directly proportional to RLC RTT; for NTN, the HARQ RTT may be up to 500 ms (10 times more than worst case RLC RTT); RLC RTT may (e.g., currently) assume some HARQ retransmissions for reliability of RLC ACK. By re-using this assumption, the memory requirement may be 30-60 times greater for NTN WTRU as compared with a WTRU connected to a terrestrial base station (e.g., gNB).

High-reliable HARQ (e.g., using stop and wait HARQ ACK) may introduce unnecessary delay such that: throughput may be (e.g., severely) limited-MAC may not accept new data if HARQ processes are retransmitting, and retransmissions depend on the HARQ RTT-long RTT means long retransmission times; L2 memory requirement may be excessive; automatic retransmission of every HARQ PDU to obtain reliability may (e.g., severely) impact capacity (e.g., 2 or 3 times unnecessary transmissions).

If HARQ retransmissions are removed, then 10 times memory requirement may be necessary, and any of the following problems may occur: protocol stalling if AM RLC may be used—not enough memory to accept more new data if any RLC ACK is lost over the air; and if RLC UM is used, then TCP throughput will be degraded due to congestion detection in TCP protocol.

Even for shorter RTT (e.g., LEO satellite may have as little as 25 ms HARQ RTT), the performance may be impacted (e.g., current assumption of 50 ms RLC RTT is no longer reasonable if we consider HARQ retransmissions) such that: (i) HARQ feedback enabling 3 HARQ retransmissions may result in (4*32=128 ms) HARQ delay causing increased memory requirement in the WTRU even if poll triggers are set such that RLC RTT=128 ms. Further, with HARQ operation set to “normal” the protocol stalling may occur at HARQ due to the number of processes being limited to 32 When HARQ errors occur, the HARQ process may not accept new data from RLC due to having to buffer the data for retransmission; (ii) disabling HARQ to boost throughout may not work due to unreliable RLC Tx window management and/or TCP throughput being throttled—throughput will anyway be affected due to errors further up the stack.

Below are examples for improving throughput. The NTN scenarios discussed above and the embodiment for improving throughput discussed below are non-limiting examples. The embodiment discussed below may be applicable to any scenario wherein the radio network has an inherently long RTT.

For improving throughput, the WTRU may change its data transmission behavior depending on the type of data being sent by RLC (e.g., data PDU, status PDU, re-transmissions, etc.). The enhancement may maximise the achievable throughput, while minimising overhead (e.g., control signalling and unnecessary retransmissions), minimising the WTRU memory requirement while maintaining the reliability.

In an embodiment, wherein the mechanism for improving throughput is limited to RLC layer, transmitting RLC entity may set the poll bit on multiple consecutive PDUs to trigger/to perform multiple status reports, ensuring status reports may be more reliably received (triggering receiver to send multiple STATUS reports to compensate for potential loss). Receiving RLC entity may repeat a status report transmission. Receiving RLC entity may detect RLC sequence number (SN) gap and trigger STATUS report without poll. Transmitting RLC entity may automatically repeat retransmission PDUs multiple times, while initial transmissions are sent only once.

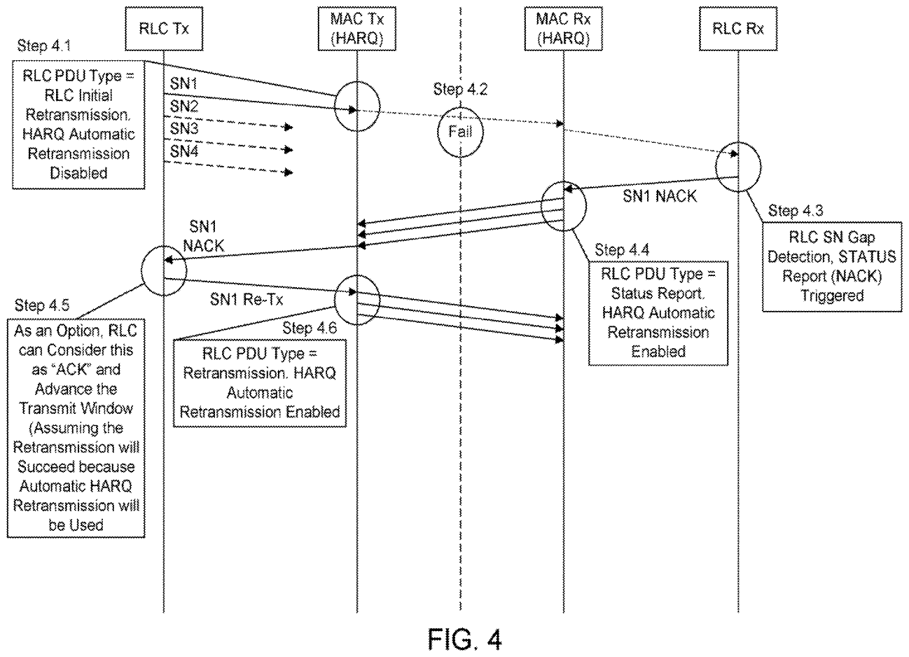

In an embodiment, as depicts at FIG. 4, the WTRU may change its data transmission behaviour for improving throughput thanks to MAC with RLC PDU indication. The MAC (e.g., HARQ) handling may depend on RLC PDU type indication from RLC. The message sequence chart in FIG. 4 shows example of adapting HARQ operation based on RLC PDU type. Such method may achieve better performance than previously described RLC method due to redundancy versions of HARQ/soft buffer combining (e.g., HARQ (re) transmissions can be combined to achieve higher reliability).

Referring to the example in FIG. 4, an example of operation may be as follows:

At step 4.1, the transmitting RLC entity (RLC Tx) (e.g., in the WTRU) may provide data to the MAC entity (MAC Tx) (e.g., also in the WTRU) on each transmission time interval (TTI) incrementing the RLC sequence number (SN1-SN4) for each new transmission. The RLC PDU may be indicated to MAC—in the case of new transmission the RLC PDU type may be indicated as “acknowledged mode data (AMD) PDU initial transmission”.

The MAC Tx layer may receive RLC PDUs from the RLC Tx layer. The RLC PDU type may determine the mode of HARQ transmission at the MAC layer. In case of “AMD PDU initial transmission” the HARQ mode may be a first mode which may be a mode without any retransmissions, or the first mode may use a limited number of retransmissions or repetitions.

At step 4.2, if the HARQ transmission fails (over the air transmission from the transmitting MAC entity (MAC Tx) to the receiving MAC entity (MAC Rx) via the physical layer) then the corresponding RLC PDU may not be received at the receiving RLC entity (RLC Rx).

At Step 4.3, an AM RLC entity may send STATUS PDUs to its peer AM RLC entity in order to provide positive and/or negative acknowledgements of RLC PDUs (or portions of them).

Upon detection of reception failure of an AMD PDU, the receiving RLC entity (RLC Rx) may trigger/perform a STATUS PDU which contains negative acknowledgement of the missing RLC SN. The receiving RLC entity (RLC Rx) (e.g., in the NW) may provide the STATUS PDU to the receiving MAC layer (MAC Rx) (e.g., also in the NW) and the RLC PDU type may be indicated as “STATUS PDU”.

At step 4.4, the MAC layer may receive RLC PDUs from the RLC layer. The RLC PDU type may determine the mode of HARQ transmission at the MAC Rx layer. In case of “STATUS PDU” the HARQ mode may be a second mode with an increased number of retransmissions or repetitions compared to the first mode in order to improve the reliability of HARQ transmission.

The MAC entity (MAC Tx) at the transmitting side may successfully receive the RLC STATUS PDU and may provide this to the transmitting RLC entity (RLC Tx). This may trigger/perform a retransmission of the missing RLC AMD PDU.

At step 4.5, the transmitting RLC entity (RLC Tx) may provide the missing RLC AMD PDU again to the MAC entity. The RLC PDU may be a retransmission and therefore the RLC PDU type indicated to MAC may be “AMD PDU retransmission”. The transmitting AM RLC entity may assume the retransmission will be successfully delivered and update the state variables controlling the RLC transmission window such that the window is advanced.

At step 4.6, the MAC layer may receive RLC PDUs from the RLC layer. The RLC PDU type may determine the mode of HARQ transmission at the MAC layer. In case of “AMD PDU retransmission” the HARQ mode may be a second mode with an increased number of retransmissions or repetitions compared to the first mode in order to improve the reliability of HARQ transmission. The HARQ mode may alternatively be a third mode, with an increased number of retransmissions or repetitions compared to the first mode, but a different number of retransmissions or repetitions compared to the second mode used for STATUS PDUs.

More generally, the HARQ process may enable ACK/NACK feedback or alternatively may use blind retransmission or repetitions of HARQ PDUs (e.g., retransmit without waiting for ACK/NACK feedback) when RLC status report is sent. In addition to RLC ACK, HARQ retransmissions may be enabled only for RLC retransmissions (e.g., not initial transmission): (i) TTI bundling may be an alternative way to perform blind retransmission; (ii) the number of repetitions or retransmissions depends on the RLC PDU type. Certain types of data may require a higher number of repetitions; (iii) the HARQ operation type may have multiple modes, for example a first RLC transmission may use no ACK/NACK feedback and no blind retransmission, a second transmission (first retransmission) may use ACK/NACK feedback, and a third transmission (second retransmission) may use blind retransmission; (iv) the RLC transmit window may be advanced even if a PDU has been negatively acknowledged, assuming that the mechanism for transmitting the retransmitted RLC PDU is robust and no further RLC retransmission is needed.

Network may configure some HARQ processes with no feedback and other HARQ processes with ACK/NACK feedback enabled or automatic retransmission enabled. RLC or MAC may utilize one type of HARQ process for initial RLC transmissions and another type of HARQ process for retransmissions and/or STATUS reports. Selection of HARQ type may be done by the RLC entity or may alternatively be performed as part of the logical channel prioritization process in MAC.

In various embodiments, throughput may be improved by changing WTRU data transmission, such that: (i) cell quality/channel quality indicator (CQI) may be used to enable/disable or increase/decrease blind HARQ retransmission or repetitions at MAC or RLC layer. HARQ RTT retransmission timer may be toggled based on CQI. Retransmissions to be enabled based on low CQI, while a higher CQI may be used to disable retransmissions. (ii) Initial HARQ ACK/NACK may enable/disable blind HARQ retransmission at MAC. For example, if a 1st HARQ transmission is NACKED, then perform multiple retransmissions automatically without waiting for ACK/NACK. This may be used in case HARQ RTT<32 ms (32 HARQ processes) since the initial HARQ feedback could be received before the next HARQ transmission opportunity. (iii) a hybrid RLC mode may be used—an RLC entity may be configured as UM and switch to AM. The RLC mode may be switched based on CQI. The RLC mode may be switched based on HARQ errors detected, and indicated from MAC to RLC. The RLC mode may be switched based on PDCP PDU type (similar to Alt.2 but handled by RLC). A detection of rate of UM RLC Rx failures may trigger/perform the receiving RLC entity to send a STATUS Report to transmitter to toggle switch to AM. (iv) Out of order HARQ scheduling. Retransmitted HARQ PDUs may be sent on consecutive TTIs instead of waiting e.g., 32 ms between each transmission—i.e. one HARQ process transmits for N TTIs before the next HARQ process is scheduled.

Below are examples of methods performed at RLC level. In the following embodiments, RLC level operation (e.g., polling, status reporting, sending of RLC data PDUs, etc.) are proposed to optimize operations in high RTT networks.

In the following embodiments, polling is adaptative and frequent.

In an embodiment, the transmitting RLC entity of the WTRU may be configured to set the poll bit on multiple PDUs such that multiple status reports may be triggered/performed from the receiving RLC entity.

In one embodiment, the multiple PDUs may be consecutive.

In one embodiment, the multiple PDUs may not be consecutive (depending on configured pattern, e.g., every other PDU, etc.,).

In one embodiment, the WTRU may apply a configured (e.g., static) pollPDU or pollByte to decide to send a polling, and once it has decided to set the polling bit based on this, it may trigger/perform to send the polling on multiple PDUs.

In one embodiment, the WTRU may decide to trigger/to perform the polling even if the conditions for triggering/for performing a polling are not fulfilled according to the configured pollPDU or pollByte or pollRetransmit setting and set the polling bit on multiple PDUs.

In one solution, the WTRU may be configured with thresholds related to a radio signal corresponding to radio conditions (e.g., RSRP/Reference Signal Received Quality (RSRQ)/SINR thresholds). In condition that a radio signal level corresponding to radio conditions to/from the serving cell (i.e., UL or DL) falls below this threshold, the polling frequency may be increased (e.g., decrease the poll PDU value, decrease the poll byte value, decrease the poll retransmit timer, etc.). Similarly, in condition that the radio signal level is above a configured threshold related to radio conditions, the polling frequency may be decreased.

In various embodiments (e.g., Time Division Duplexing (TDD) where UL and DL use the same frequency), the UL signal level may be determined by the DL signal level measured by the WTRU (specifically if measuring RSRP levels, as that does not consider interference and noise, and as such a simple power scaling based on WTRU and network transmission power levels may be sufficient). In other embodiments (e.g., Frequency Division Duplex (FDD) where UL and DL use different frequencies), the WTRU may estimate the UL signal level based on the DL signal level based on some mapping.

In one embodiment, the WTRU may be configured with thresholds related to WTRU buffer levels (e.g., used buffer space, available buffer space, etc.). In condition that the buffer thresholds are met (e.g., available buffer below a certain configured threshold), the WTRU may trigger/perform transmission of a polling or increase the polling frequency (e.g., decrease the poll PDU value, decrease the poll byte value, decrease the poll retransmit timer, etc.). The buffer level thresholds may be total buffer available for the WTRU, total buffer available at RLC level (for all bearers), total buffer available for bearers of specific QoS, total buffer available for the RLC entity of the concerned bearer, etc. Similarly, buffer thresholds may be set that are used to decide to decrease the polling frequency (e.g., when available buffer is above a configured threshold, decrease the polling frequency by a certain amount)

In one embodiment, instead of buffer levels, the WTRU may be configured with UL data rate levels (instead or in addition to buffer levels) to decide when to trigger/to perform the sending of a polling or when to increase/decrease the polling frequency.

In one embodiment, the WTRU maybe configured to trigger/to perform a polling or adjust the polling frequency depending on the RLC RTT. For example, the WTRU may be configured to increase the polling frequency (e.g., decrease the poll_PDU value) when it has determined the RLC RTT has been increasing or has increased by a certain configured amount (e.g., as compared to a baseline RLC RTT value).

In one embodiment, the number of repetitions may be static (e.g., a configured number of values, n)

In one solution, the number of repetitions may be dynamic/adaptive, depending on several factors such as radio conditions, available/used buffer status level, measured/estimated RLC RTT, etc. For example, the WTRU may be configured with a default value of repetitions to apply. In case of bad radio conditions, the default value of repetition may be increased by the WTRU. In case of good radio conditions, it may decrease the value of repetitions to apply.

Below are embodiments for status report repetition

In an embodiment, the receiving RLC entity may be configured to send status reports a multiple number of times to increase the reliability of reception of the reports, which will further ensure the needed retransmissions at the peer RLC entity will happen as fast as possible.

In an embodiment, the WTRU may be configured with thresholds related to radio conditions (e.g., RSRP/RSRQ/signal-to-noise and interference ratio (SINR) thresholds), and when the signal level of the serving cell falls below this threshold, it may repeat the status reports that it is sending a certain configured number of times.

In one embodiment, the number of repetitions may be fixed.

In one embodiment, the number of repetitions may depend on several factors such as: (i)_How much the signal level is below (in absolute or relative terms) the specified radio threshold for sending the repetitions, (ii) how many missing PDUs are detected in the RLC receive window, (iii) the current RLC receive buffer level (total, available, per bearer, etc.)

Below are examples of status report triggering without poll reception

In one embodiment, the receiving RLC entity may be configured to send status reports without the reception of a polling from the transmitting RLC entity, depending on the SN gap at the RLC receive window. For example, the receiving RLC entity may be configured to automatically trigger or perform a status report if it detects n or more missing PDUs in the RLC receive window (e.g., PDU with SN x and PDU with SN x+n+1 are received but not the ones in between). In another example, the receiving RLC entity may be configured to automatically trigger or perform a status report if it detects that the difference between the highest SN and first in sequence expected SN is above n.

In an embodiment, the receiving RLC entity of the WTRU may be configured to send status reports without the reception of a polling from the transmitting RLC entity, depending on the radio signal level. For example, the WTRU may be configured to automatically trigger or perform a status report if it detects the DL signal level has fallen below a specified threshold (e.g., RSRP/RSRQ/SNIR) for a certain duration.

In one embodiment, the receiving RLC entity of the WTRU may be configured to send status reports without the reception of a polling from the transmitting RLC entity, depending on the WTRU buffer levels. For example, the WTRU may be configured to automatically trigger or perform a status report if it detects that the available RLC buffer space is below a specified threshold (e.g., RSRP/RSRQ/SNIR) for a certain duration.

Below are examples of pre-emptive repetition of RLC PDUs

In one embodiment, the transmitting RLC entity of the WTRU may be configured to transmit RLC PDUs a configurable number of times, depending on several factors.

In one embodiment, the repetition may be performed for retransmitted PDUs and not for PDUs being transmitted for the first time.

In one embodiment, the repetition may be performed for PDUs which have the polling bit set.

In one embodiment, a repetition (for retransmitted PDUs or PDUs that have the polling bit set) depend on radio conditions (e.g., when the signal level of the serving cell falls below a certain threshold).

In one embodiment, a repetition may (for retransmitted PDUs or PDUs that have the polling bit set) depend on buffer conditions (e.g., when the available/used RLC buffer level is below/above a certain threshold).

In one embodiment, a repetition for any PDU (i.e., first transmissions, retransmissions, or PDU that may or may not have the polling bit set) may depend on radio conditions (e.g., when the signal level of the serving cell falls below a certain threshold).

In one embodiment, a repetition for any PDU (i.e., first transmissions, retransmissions, or PDU that may or may not have the polling bit set) may depend on buffer conditions (e.g., when the available/used RLC buffer level is below/above a certain threshold).

In one embodiment, the number of repetitions may be fixed.

In one embodiment, the number of repetitions may depend on several factors such as: (i) How much the signal level is below (in absolute or relative terms) a specified radio threshold for sending the repetitions; (ii) the current RLC transmit buffer level (total, available, per bearer, etc.); (iii) whether the poll was triggered/performed due to poll_PDU or poll_BYTE; (iv) the estimated RTT.

Below is an example of a method performed at MAC level.

In the following embodiments, MAC level operation (e.g., polling, status reporting, sending of RLC data PDUs, etc.) are proposed to optimize operations in high RTT networks.

In one embodiment, the transmitting RLC entity of the WTRU may be configured to transmit MAC PDUs a configurable number of times, depending on the type/content of the RLC PDU(s) that are being carried in the MAC PDU.

In one embodiment, the repetition may be performed at the MAC level for RLC PDUs containing status reports (e.g., MAC identifying this from the RLC header of the RLC packet or from a separate indication from RLC to MAC).

In one embodiment, the repetition may be performed at the MAC level for RLC PDUs with the polling bit set (e.g., MAC identifying this from the RLC header of the RLC packet or from a separate indication from RLC to MAC).

In one embodiment, the repetition may be performed at the MAC level for RLC PDUs that are being retransmitted. RLC may add a new field (e.g., 0 representing first transmissions, 1 representing retransmissions) in the RLC header or use a separate indication from RLC to MAC.

In one embodiment, a given RLC bearer may be associated with multiple logical channel identifiers (LCIDs), where the different logical channels are associated with first transmissions, retransmissions, status reports, or PDUs that have the polling bit set. For example, an RLC bearer may be configured with 2 LCIDs (e.g., LCID x and LCID y), where the first transmissions are associated with LCIDx and retransmissions are put on LCIDy. The MAC may apply different behavior depending on which LCID a packet is associated with (e.g., repetition performed on all packets associated with LCIDy but no on LCIDx).

In NR, a MAC PDU may contain a concatenation of several RLC PDUs. In one embodiment, the WTRU may be configured to refrain from multiplexing RLC PDUs of different type within a given PDU (e.g., a MAC PDU may contain only first transmission, a MAC PDU may contain only retransmitted PDUs, etc).

In one embodiment, the WTRU may be configured to perform multiplexing different RLC PDU types (e.g., one containing first transmissions, another one containing retransmission), and the WTRU may be further configured to apply different behaviors that considers the types of the multiplexed RLC PDUs. For example, if the MAC PDU contains one RLC PDU that is being transmitted for the first time and another one that is being retransmitted, the WTRU may apply the behavior associated with retransmitted PDUs (e.g., perform repetition). In another example, no repetition may be performed unless all the RLC PDUs within a MAC PDU are of the same type.

In one embodiment, the MAC level repetition may depend on radio conditions (e.g., when the signal level of the serving cell falls below a certain threshold). Such embodiment may be independent from or combined with the repetition based on RLC PDU type. For example, retransmitted RLC PDUs are repeated only if the radio signal level is below a certain threshold, while RLC status reports are always repeated regardless of the radio signal level.

In one solution, the MAC level repetition may depend on measured HARQ failure rate (e.g., when a certain number of NACKs are received, where the percentage of NACKs increases by a certain rate/level, etc.,) Such embodiment may be independent from or combined with the repetition based on RLC PDU type. For example, retransmitted RLC PDUs are repeated only if HARQ failure rate is above a certain threshold, while RLC status reports are always repeated regardless of the HARQ failure rate.

In one embodiment, the MAC level repetition may depend on buffer conditions (e.g., when the available buffer at the WTRU falls below a certain threshold). Such embodiment may be independent from or combined with the repetition based on RLC PDU type. For example, retransmitted RLC PDUs are repeated only if the available buffer is below a certain threshold, while RLC status reports are always repeated regardless of the radio signal level.

In one embodiment, the number of repetitions may be fixed.

In one embodiment, the number of repetitions may depend on several factors such as: (i) how much the signal level is below (in absolute or relative terms) a specified radio threshold for sending the repetitions; (ii) the current WTRU buffer level (total, available, per bearer, etc.); (iii) RLC PDU/Data type; (iv) estimated RTT.

Below is example of repetition coordination between RLC and MAC

As described above there are a number of methods to ensure transmission reliability: RLC retransmissions, HARQ retransmission, repetition scheduled using the same downlink control information (DCI) or repetition scheduled via a different DCI (e.g., blind retransmission). In this set of embodiments, repetition methods used in RLC and or MAC may be coordinated to ensure that the appropriate trade-off between reliability and throughput is achieved based on, for example, QoS requirements and or channel conditions.

Within the following section, “enabled” HARQ UL retransmission may refer to a grant for which there will be or may likely be an UL retransmission grant provided. For example, this may refer to a semi-static configuration, or some configuration/indication which may notify the WTRU that subsequent retransmission grants would be considered likely e.g., based on discontinuous reception (DRX) timer behaviour (e.g., DRX-HARQ-RTT-TimerUL value offset by WTRU-gNB RTT) or based on configuration of Logical Channel Prioritization (LCP) parameters. “disabled” HARQ UL retransmission may refer to a grant for which there will be no retransmission or retransmission is unlikely. This may be indicated via semi-static configuration, or some configuration/indication which may notify the WTRU subsequent retransmission grants are considered unlikely e.g., based on DRX timer behaviour (e.g., not starting the retransmission timer) or based on configuration of LCP parameters.

In one embodiment, and RLC mode may be toggled depending on whether HARQ UL retransmissions or DL HARQ feedback is enabled. For example, an UL grant may be associated to a HARQ PID for which UL HARQ retransmission may be configured as “disabled”. Any RLC PDUs which may be multiplexed onto this grant may be considered as having e.g., RLC UM.

In one embodiment, UL HARQ grants may be associated to a HARQ PID for which UL retransmission is “enabled”. Any RLC PDUs which may be multiplexed onto this grant may be considered as having e.g., RLC AM.

In one embodiment, WTRU may modify when it is monitoring physical downlink control channel (PDCCH) for an UL retransmission grant (e.g., when WTRU is in DRX active time) based on RLC mode. In one example, if WTRU has RLC AM mode, WTRU may monitor for retransmission grant after WTRU-gNB RTT (e.g., WTRU will increase the value of the DRX-HARQ-RTT-TimerUL by WTRU gNB RTT, or offset the start of the DRX-RetransmissionTimerUL). In another example, if WTRU has RLC UM mode, the WTRU may not monitor for retransmission grant e.g., the WTRU may not start the DRX-retransmissionTimerUL and/or DRX-HARQ-RTT-TimerUL.

In one embodiment, the WTRU may monitor for a blind retransmission grant (e.g., set the DRX-HARQ-RTT-TimerUL to zero, or start the DRX-RetransmissionTimerUL an offset after completion of the initial PUSCH transmission) based on one or more of the following: (i) the WTRU may monitor for blind retransmission grant based on the RLC mode e.g., RLC AM/UM; (ii) the WTRU may monitor for blind retransmission grant based on whether the UL grant was assigned to a HARQ PID with HARQ UL retransmission “enabled” or “disabled”; (iii) the WTRU may monitor for blind retransmission grant based on the channel condition (e.g., CQI, measured RSRP/RSRQ). In one example the WTRU may monitor for retransmission grant, if the RSRP falls below a configured threshold.

In one embodiment, the service data application protocol (SDAP) layer may provide an indication per PDCP packet or per logical channel related to the priority of the data, which enables/disables or increases/decreases the PDU repetition at RLC or MAC layer for individual services.

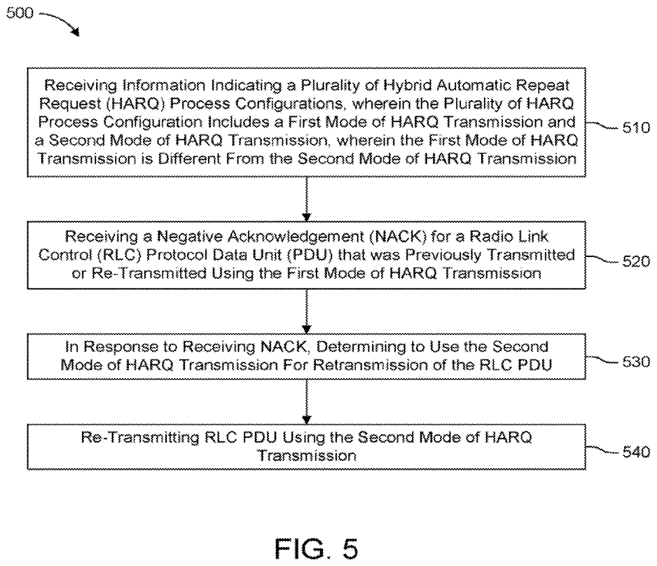

Referring to FIG. 5, an example of a method 500 implemented in a WTRU, for throughput performance improvement may comprise a step of receiving 510 information indicating a plurality of hybrid automatic repeat request HARQ process configurations, wherein the plurality of HARQ process configuration includes a first mode of HARQ transmission and a second mode of HARQ transmission, wherein the first mode of HARQ transmission is different from the second mode of HARQ transmission. The method may further comprise a step of receiving 520 a negative acknowledgement NACK for a radio link control RLC protocol data unit PDU that was previously transmitted or re-transmitted using the first mode of HARQ transmission. The method may further comprise a step, wherein in response to receiving NACK, determining 530 to use the second mode of HARQ transmission for retransmission of the RLC PDU. The method may further comprise a step of re-transmitting 540 the RLC PDU using the second mode of HARQ transmission.

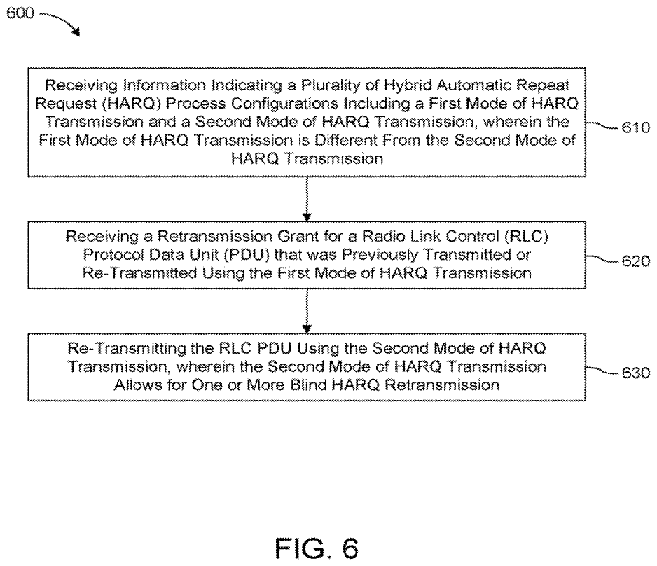

Referring to FIG. 6, another example of a method 600 implemented in a WTRU, for throughput performance improvement may comprise a step of receiving 610 information indicating a plurality of hybrid automatic repeat request HARQ process configurations including a first mode of HARQ transmission and a second mode of HARQ transmission, wherein the first mode of HARQ transmission is different from the second mode of HARQ transmission. The method 600 may comprise a step of receiving 620 a retransmission grant for a radio link control RLC protocol data unit PDU that was previously transmitted or re-transmitted using the first mode of HARQ transmission. The method 600 may further comprise a step of re-transmitting 630 the RLC PDU using the second mode of HARQ transmission, wherein the second mode of HARQ transmission allows for one or more blind HARQ retransmissions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented in a wireless transmit/receive unit (WTRU) comprising:
receiving information indicating a first mode of HARQ transmission and a second mode of HARQ transmission;
transmitting a radio link control (RLC) protocol data unit (PDU) using the first mode of HARQ transmission;
receiving a message comprising first information indicating an RLC negative acknowledgement (NACK) for the RLC PDU using the first mode of HARQ transmission;
in response to receiving the first information indicating an RLC NACK, retransmitting the RLC PDU using the second mode of HARQ transmission; and
wherein the first mode of HARQ transmission allows for HARQ transmission with no HARQ feedback, and wherein the second mode of HARQ transmission allows for HARQ feedback.

2. The method of claim 1, wherein the first mode of HARQ transmission allows for a single HARQ transmission, and wherein the second mode of HARQ transmission allows for one or more HARQ automatic retransmissions.

3. The method of claim 1, wherein the first mode of HARQ transmission allows for one or more HARQ transmissions without HARQ feedback, and wherein the second mode of HARQ transmission allows for at least one of one or more HARQ automatic retransmissions and one or more blind retransmissions.

4. The method of claim 1, wherein the first mode of HARQ transmission comprises a first number of retransmissions, wherein the second mode of HARQ transmission comprises a second number of retransmissions.

5. The method of claim 1, wherein a transmit window associated with a prior transmission of the RLC PDU is advanced responsive to at least one of receiving an RLC NACK and determining to use the second HARQ mode of transmission.

6. The method of claim 1, comprising retransmitting the RLC PDU using the second mode of HARQ transmission on condition that the RLC PDU was transmitted using the first mode of HARQ transmission.

7. The method of claim 1, comprising using the second mode of HARQ transmission for retransmission of the RLC PDU based on a channel quality indicator.

8. The method of claim 1, comprising:
determining that a type of the RLC PDU is indicated as an acknowledged mode data (AMD) PDU initial transmission; and
wherein transmitting the RLC PDU using the first mode of HARQ transmission is on condition that the type of RLC PDU is indicated as an AMD PDU initial transmission.

9. The method of claim 8 comprising:
in response to receiving the first information indicating the RLC NACK, determining to retransmit the RLC PDU, wherein the type of the RLC PDU is indicated as an AMD PDU retransmission; and
on condition that the type of RLC PDU is indicated as an AMD PDU retransmission, retransmitting the RLC PDU using the second mode of HARQ transmission.

10. A method implemented in a wireless transmit/receive unit (WTRU), comprising:
receiving information indicating a first mode of hybrid automatic repeat request (HARQ) transmission and a second mode of HARQ transmission;
receiving a retransmission grant for a radio link control (RLC) protocol data unit (PDU) that was transmitted using the first mode of HARQ transmission; and
retransmitting the RLC PDU using the second mode of HARQ transmission, wherein the second mode of HARQ transmission allows for one or more blind HARQ retransmissions.

11. The method of claim 10, wherein the first mode of HARQ transmission comprises a first number of retransmissions, wherein the second mode of HARQ transmission comprises a second number of retransmissions.

12. A wireless transmit/receive unit (WTRU) comprising a processor, a transmitter, a receiver and memory, configured to:
receive information indicating a first mode of hybrid automatic repeat request (HARQ) transmission and a second mode of HARQ transmission;
transmit a radio link control (RLC) protocol data unit (PDU) using the first mode of HARQ transmission;
receive a message comprising first information indicating an RLC negative acknowledgement (NACK) for the RLC PDU using the first mode of HARQ transmission;
retransmit the RLC PDU using the second mode of HARQ transmission, in response to receiving the first information indicating an RLC NACK; and
wherein the first mode of HARQ transmission allows for HARQ transmission with no HARQ feedback, and wherein the second mode of HARQ transmission allows for HARQ feedback.

13. The WTRU of claim 12, wherein the first mode of HARQ transmission allows for a single HARQ transmission, and wherein the second mode of HARQ transmission allows for one or more HARQ automatic retransmissions.

14. The WTRU of claim 12, wherein the first mode of HARQ transmission allows for one or more HARQ transmissions without HARQ feedback, and wherein the second mode of HARQ transmission allows for at least one of one or more HARQ automatic retransmissions and one or more blind retransmissions.

15. The WTRU of claim 12, wherein the first mode of HARQ transmission comprises a first number of retransmissions, wherein the second mode of HARQ transmission comprises a second number of retransmissions.

16. The WTRU of claim 12, wherein a transmit window associated with a prior transmission of the RLC PDU is advanced responsive to at least one of receiving an RLC NACK and determining to use the second HARQ mode of transmission.

17. The WTRU of claim 12, configured to retransmit the RLC PDU using the second mode of HARQ transmission on condition that the RLC PDU was transmitted using the first mode of HARQ transmission.

18. The WTRU of claim 12 configured to use the second mode of HARQ transmission for retransmission of the RLC PDU based on a channel quality indicator.

19. The WTRU of claim 12, configured to:
determine that a type of the RLC PDU is indicated as an acknowledged mode data (AMD) PDU initial transmission; and
wherein transmitting the RLC PDU using the first mode of HARQ transmission is on condition that the type of RLC PDU is indicated as an AMD PDU initial transmission.

20. The WTRU of claim 19 configured to:
in response to receiving the first information indicating the RLC NACK, determine to retransmit the RLC PDU, wherein the type of the RLC PDU is indicated as an AMD PDU retransmission; and
retransmit the RLC PDU using the second mode of HARQ transmission, on condition that the type of RLC PDU is indicated as an AMD PDU retransmission.
